(19) United States
(12) Patent Application Publication
(10) Pub. No.: US 2007/0013800 A1
(43) Pub. Date: Jan. 18, 2007

(54) Viewfinder eyepiece assembly

(76) Inventor: William Bruce Pope, Atlanta, GA (US)

Correspondence Address: GEORGE R. REARDON, 3356 STATION COURT, LAWRENCVILLE, GA, 30044, US

(21) Appl. No.: 11/181,249

(22) Filed: Jul. 14, 2005

(51) Int. Cl. H04N 5/222

(52) U.S. Cl. 348/333.01

(57) ABSTRACT

The present invention relates generally to a viewfinder eyepiece assembly for improving the optical accuracy and safety of an electronic news gathering video camera. The viewfinder eyepiece replaces the camera's dust cover plate assembly in the eye side opening of the viewfinder body. The viewfinder eyepiece assembly is comprised of at least two plates framed within a flexible carrier where the multiple-plate configuration creates an essentially airtight space between the plates. This space serves to slow down the cooling of the external eyepiece plate, thus decreasing the likelihood of condensation forming on this plate in cold weather. Additionally, one of the plates may use the user's refractive prescription for personalized viewfinder focus. Furthermore, one of the plates may be made of a material, or treated with a coating, that acts as barrier to certain harmful electromagnetic field emissions, while being transparent to light frequencies in the harmless visible range.

### FIELD OF THE INVENTION

The present invention is directed to videotaping cameras. More particularly, this invention relates to an improved eyepiece assembly for the viewfinder of a portable videotape camera.

### BACKGROUND OF THE INVENTION

In the mid-1970s, lightweight television cameras were developed for rapid response, on-the-scene videotaping. These battery-powered cameras were created to allow cameramen to operate without a crew in almost any environment. Within the television and video industry, these became generally known as electronic newsgathering cameras, or ENGs. The most commercially successful ENG camera has been the Sony Betacam, of which over 400,000 have been sold in the world since the early 1980s.

The design of these portable video cameras positions the body of the camera on the cameraman's shoulder, to the side of his head. To monitor his videotaping, a short viewing tube, or viewfinder, was created. Unlike those of still cameras, the ENG viewfinder is not a window onto the actual scene in front of the camera. It acts as a microscope that magnifies and focuses onto a 1.5 inch cathode ray tube (CRT) about 3 inches from the user's eye. The CRT is displaying a real-time view of the videotaping.

The ENG viewfinders have three primary functions:
a. To block out external light that would wash out the images on the monitor screen, i.e., to facilitate the blocking out of unwanted light, the cameraman must firmly press his camera-side eye against a rubber eyecup.
b. To hold an internal focusing lens, i.e., since the video monitor is only a few inches from the viewer's eye, a biconvex focusing lens is present to magnify and focus the small display. In some models, the viewfinder also displays operating information such as tape status and battery level.
c. To maintain the viewer's eye at a constant distance from the monitor screen, especially when in motion.

The present design of the ENG viewfinder has created several problems. The most obvious challenge is for cameramen who normally require glasses to see clearly. To maximize the viewfinder's functions, the user must firmly press one eye against the viewfinder's soft rubber eyecup. For a comfortable and effective fit against the eyecup, a bespectacled cameraman must remove his glasses. The standard ENG viewfinder optics is designed for the distance-corrected user with an internal focusing lens that offers an optical adjustability range of only 3 diopters. This presents a vision problem for the cameraman who wishes to remove his glasses when using the viewfinder and whose level of uncorrected myopia, hyperopia, or presbyopia is beyond the viewfinder's adjustable focusing range. The current design of the ENG viewfinder offers no mechanism for personalizing the viewfinder optics to compensate for the removal of corrective spectacles.

There are also health concerns for ENG cameramen. The ENG camera and its viewfinder were designed in the 1970s, long before health care professionals began to implicate some electromagnetic fields as hazardous to human tissue. When using the viewfinder to monitor his videotaping, the ENG cameraman's eye is only a few inches from the monitor. This exposes the ENG cameraman to electromagnetic field (EMF) radiation emitted from the CRT. A large body of evidence now exists showing that some of these radiations can cause health problems and that exposure should be minimized.

The ENG designers also did not anticipate a viewfinder fogging problem. They placed a very thin piece of glass, a cover plate, within the user-end opening of the viewfinder tube. Its only function is to keep debris out of the viewfinder body. When the cameraman presses his eye firmly against the eyecup, a small chamber is formed between his eye and the cover plate. As he uses the viewfinder his body adds warmth and moisture to the air within this chamber. If the air within the internal viewfinder chamber is cold, as in frigid weather, the eye-side of the cover plate eventually cools down too. If the dew point is reached, the eye chamber moisture condenses onto the cover plate. In insulation technology terms, this thin cover plate has a very low R-value. It has little ability to insulate the eye chamber, or impede the flow of heat from the eye chamber to the viewfinder's colder internal chamber. This condensation, or fogging, can obscure the cameraman's view of the monitor at the other end of the viewfinder.

Existing art of ENG video viewfinder eyepieces consists of only the original dust cover plate assembly. Its sole function is to keep debris out of the main viewfinder body, and, therefore, affect the user's view of the monitor image as little as possible. This assembly consists of a thin, glass plate possessing a continuous edge, and two flat surfaces that have a parallel relationship with each other; such that light rays pass through the plate substantially uninterrupted, without deviation or distortion; and an elastomer carrier which surrounds the edge of this plate providing securing means for the cover plate assembly into the viewing tube such that the cover plate is positioned between the ENG video camera monitor and a viewer's eye, and the surfaces of the cover plate are held in a substantially perpendicular relationship to the viewer's visual axis. Nothing about the design of the existing cover plate assembly indicates an acknowledgement of, or desire to address, any of the aforementioned problems of user refractive error, hazardous EMF emissions from the monitor, or the tendency for condensation to fog the cover plate in cold environments.

Related patents include:
a. U.S. Pat. No. 5,555,468, issued to Miura, discloses a viewfinder device for a camera which has reflection components having reflective surfaces which reflect light through focus plate and condenser lens of camera.
b. U.S. Pat. No. 3,635,756, issued to Shepherd, which discloses a transparent non-fogging coating is applied to a normally fogging transparent or reflecting substrate. The non-fogging coating preferably comprises a hydrophilic acrylate or methacrylate polymer. The polymer can be modified by copolymerization with a monobasic or polybasic unsaturated carboxylic acid or partial ester thereof. The polymer can be cross-linked with a polyepoxide to increase its hardness. Typical substrates include automobile, train and airplane windows, sunglasses, camera lens, microscope lens, binocular lens, telescope lens, meat wrappers, diving masks, ski glasses, mirrors.
c. U.S. Pat. No. 4,621,889, issued to Chikano, which discloses a camera filter provided with an ultraviolet ray absorbing substrate, on which is deposited an evaporated film which transmits blue and green light, but which sharply attenuates a portion of the red light in the higher wavelength range. Particularly, the wavelength at which the transmission factor reaches 50% is in a range from 640 to 700 nm. The evaporated film is formed on one surface of the substrate, typically the inner surface thereof relative to the camera lens, and the filter is fitted to a frame which may be suitably attached to the camera lens.

While each of these devices addressed the problems to which they were directed, none of them were designed to personalize the optics of an ENG video camera viewfinder for a normally bespectacled cameraman who would prefer to operate his viewfinder with his glasses removed, to minimize the health hazard to human tissue exposed to the ENG monitor radiation emissions, and to minimize the fogging of the plate of an ENG viewfinder cover plate. Other problems exist that are not addressed by the cited patents.

### SUMMARY OF THE INVENTION

The present invention described herein dramatically enhances the control, performance and safety of electronic newsgathering video cameras by replacing the dust cover plate assembly with a multiple plate eyepiece assembly, thus enabling a cameraman to address at least three ENG videotaping problems:

a. Cold weather cover plate fogging,

b. Limited focus adjustment range and lack of customization capability,

c. Exposure to hazardous electromagnetic field emissions.

The present invention relates generally to a viewfinder eyepiece assembly for improving the optical accuracy, optical clarity and safety of an electronic newsgathering video camera. The viewfinder eyepiece, replaces the camera's dust cover plate assembly in the eye-side opening of the viewfinder body. The viewfinder eyepiece assembly is comprised of at least two transparent plates framed within a flexible carrier whereby the multiple-plate configuration creates at least one essentially airtight space between the plates. This space serves to slow down the cooling of the most external eyepiece plate, thus decreasing the likelihood of condensation forming on this plate in cold weather. Additionally, one or more of the plates may be a refractive plate or lens that compensates for the removal of the cameraman's glasses. Furthermore, one or more of the plates may be made of a material or treated with a coating that acts as barrier to certain harmful electromagnetic field emissions, while still essentially transparent to light frequencies in the harmless visible range.

The present invention relates to a viewfinder eyepiece assembly that replaces the current dust cover plate assembly of the viewfinder of an electronic newsgathering camera, or ENG. The viewfinder eyepiece assembly is comprised of a plate carrier having one or more inner grooves, or channels, into which two or more flat or curved-surface plates are inserted such that at least one air space is formed between two plates. More than one plate may reside within a single groove if one or more of those plates possess a concave-curved surface that faces another plate flat or concave surface within that same groove, thus creating an inter-plate space. The inter-plate space or spaces may be filled with air, transparent gas or transparent fluid in order to address fogging of the plates by delaying the movement of heat through the eyepiece assembly. The viewfinder eyepiece assembly may be further comprised of means for filtering harmful radiation emitting from the monitor. This filtering means may be in the form of a filtering coating or film that has been applied to any one or more of the surfaces of either a flat plate or a curved-surface plate within the eyepiece assembly, or may be that a flat plate or a curved-surface plate within the eyepiece assembly is made from a material, e.g. polycarbonate, that filters out harmful radiation emitting from the viewfinder monitor. One or more of the viewfinder eyepiece assembly plates may be a curved-surface refracting plate whereby the overall viewfinder optics is adjusted to match the vision needs of the cameraman.

In one embodiment, the present invention may be comprised of a thin, substantially transparent first plate possessing a continuous edge and two surfaces, and a carrier which surrounds the edge of this first plate providing holding means for the first plate into the viewing tube such that the first plate is positioned between the ENG video camera monitor and a viewer's eye, holding the surfaces of the first plate in a substantially perpendicular relationship to the viewer's visual axis. Further, the substantially transparent first plate may be selected from the group of curved-surface plates consisting of biconvex, plano-convex, convex-concave, meniscus, plano-concave, and biconcave, such that light waves passing through the first plate are refracted a predetermined amount.

The viewfinder eyepiece assembly may be further comprised of a thin, substantially transparent second plate possessing a continuous edge and two surfaces. This second plate may be an EMF filtering plate, i.e., possessing means for inhibiting predetermined electromagnetic fields from passing through the second plate; and a carrier which surrounds said edge of the second plate providing holding means for the second plate into the viewing tube such that the second plate is positioned between the monitor and a viewer's eye holding the second plate's surfaces in a substantially perpendicular relationship to the viewer's visual axis. This plate's ability to inhibit predetermined electromagnetic field radiation is not dependent upon its surface shape, i.e., flat or curved-surface filtering plates work equally well. Thus a refracting plate may also be a filtering plate.

The viewfinder eyepiece assembly is further comprised of a space between the first plate and the second plate, bounded by the plates and the plate carrier which is filled with a substantially transparent, non-solid substance such that the transfer of heat from the viewer's side of the plates to the monitor side of the plates is inhibited, thus delaying the formation of condensation on the eye-side plate. This substantially transparent, non-solid substance may be air, a gas, or a liquid. The viewfinder eyepiece assembly may be further comprised of a plurality of spaces formed by adding additional plates to the plate carrier.

It is an object of the present invention to provide a viewfinder eyepiece assembly that allows personalization of the optics such that a cameraman, who would otherwise require a spectacle correction to clearly visualize the ENG viewfinder display image, can achieve similar clear vision using said viewfinder without said spectacles.

It is an object of the present invention to provide a viewfinder eyepiece assembly that blocks potentially unhealthy EMF radiations emitted from the monitor display.

It is an object of the present invention to provide a viewfinder eyepiece assembly that retards condensation on the eyepiece surface.

It is an object of the present invention to provide a viewfinder eyepiece assembly to enable the ENG user to easily install, remove, and modify his improved eyepiece assembly.

It is an object of the present invention to provide a viewfinder eyepiece assembly that can be made of inexpensive materials.

It is a further object of the present invention to provide a viewfinder eyepiece assembly that can be easily constructed by hand or that is capable of being manufactured using existing machinery.

The aforementioned and other objects were achieved, and the above-mentioned disadvantages overcome, by the present invention by providing a viewfinder eyepiece assembly that replaces the existing cover plate for ENG video cameras and addresses the problems stated above.

In general, the present invention is comprised of an elastomer frame holding a series of substantially transparent non-refracting plates, refracting plates or filtering plates.

Replacing the original single-function, single-plate, non-refractive cover plate assembly with the present invention, gives the cameraman a more flexible, multifunctional tool for the following reasons:
a. Inappropriate optics is easily corrected. The elastomer plate carrier of the preferred embodiment allows the user to insert his own personalized refracting plates, or lenses, thereby adjusting the viewfinder optics to his own focusing range, reducing his dependence upon spectacles.
b. New monitor types, such as plasma or liquid crystal, will have electromagnetic field characteristics which are different from that of CRT displays found in most existing cameras. The cameraman can easily address a change of monitor type with the addition of or change to a filter plate with appropriate EMF blocking properties within the eyepiece assembly.
c. The tendency for the eyepiece plate to fog up in cold environments is passively reduced by the multiple-plate, inter-plate space design. Additionally, actively heating the assembly above ambient temperatures can enhance the antifogging quality of the eyepiece assembly. This heating can be done in place within the viewfinder or before inserting the plate into the viewfinder. In place of air, the inter-plate space may be filled with a special heat retaining gas or liquid, for enhanced condensation protection.

These improvements address these problems in the current art. Additional objects and advantages of the invention will be set forth in part in the description which follows, and in part will be obvious from the description, or may be learned by practice of the invention. The objects and advantages of the invention will be obtained by means of instrumentalities in combinations particularly pointed out in the appended claims.

### BRIEF DESCRIPTION OF THE DRAWINGS

The accompanying drawings illustrate a complete embodiment of the invention according to the best modes so far devised for the practical application of the principles thereof, and in which:

FIG. 1 is a perspective view of a representation of a portion of an ENG viewfinder.

FIG. 2 is an exploded perspective view of an ENG viewfinder.

FIG. 3 is a cross sectional view giving a rendition of an ENG viewfinder.

FIG. 4 shows a cross-sectional view of a viewfinder eyepiece assembly according to an embodiment of the present invention.

FIG. 5 shows a left side exploded plan view of a viewfinder eyepiece assembly according to a preferred embodiment of the present invention.

FIG. 6 shows a left side exploded perspective view of a viewfinder eyepiece assembly according to a preferred embodiment of the present invention.

FIG. 7 is a perspective view of a viewfinder eyepiece assembly according to a preferred embodiment of the present invention.

FIG. 8 is a front plan view of a viewfinder eyepiece assembly according to a preferred embodiment of the present invention.

FIG. 9 is a cross sectional view of a viewfinder eyepiece assembly according to a preferred embodiment of the present invention.

FIG. 10 is an exploded perspective view of a viewfinder eyepiece assembly according to a preferred embodiment of the present invention.

FIG. 11 is a back plan view of a viewfinder eyepiece assembly according to a preferred embodiment of the present invention.

FIG. 12 is a partial side plan view of a viewfinder eyepiece assembly carrier according to a preferred embodiment of the present invention.

FIG. 13 is a left side cross sectional view of a viewfinder eyepiece assembly with two grooves according to an embodiment of the present invention.

FIG. 14 is a left side exploded perspective view of a viewfinder eyepiece assembly with two grooves according to an embodiment of the present invention.

FIG. 15 is a left side perspective view of the ring portion with two grooves of a viewfinder eyepiece assembly according to an embodiment of the present invention.

FIG. 16 is a left side cross sectional view of a viewfinder eyepiece assembly with three grooves according to an embodiment of the present invention.

FIG. 17 is a left side exploded perspective view of a viewfinder eyepiece assembly with three grooves according to an embodiment of the present invention.

FIG. 18 is an exploded perspective view of an ENG viewfinder with a viewfinder eyepiece assembly with three grooves according to an embodiment of the present invention.

### DETAILED DESCRIPTION OF THE INVENTION

The drawings show aspects of the invention. As the drawings are described, reference will be made to the present preferred embodiments of the invention. The terminology used herein to describe the present preferred embodiments is for the purpose of clarification. The invention, however, is not intended to be limited to the specific terminology used. Terminology used to describe each element should be understood to include all technical equivalents that operate in a similar manner to accomplish similar functions.

The present invention is described in relation to a viewfinder eyepiece assembly. Nonetheless, the characteristics and parameters pertaining to various embodiments of the device and methods described herein may be applicable for other uses.

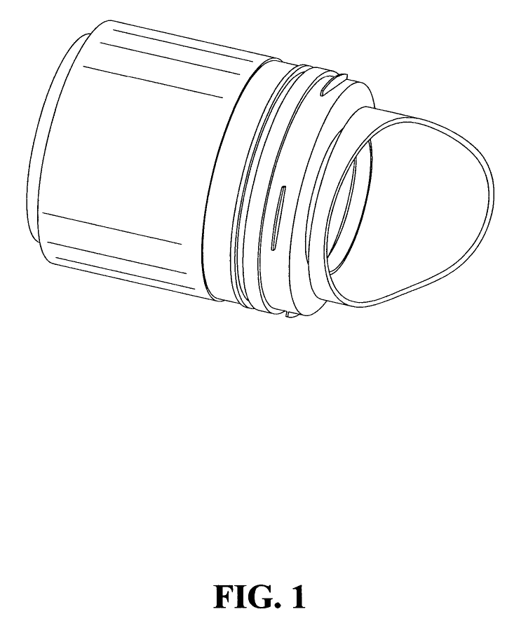

Referring to FIG. 1, related art of an ENG viewfinder is represented.

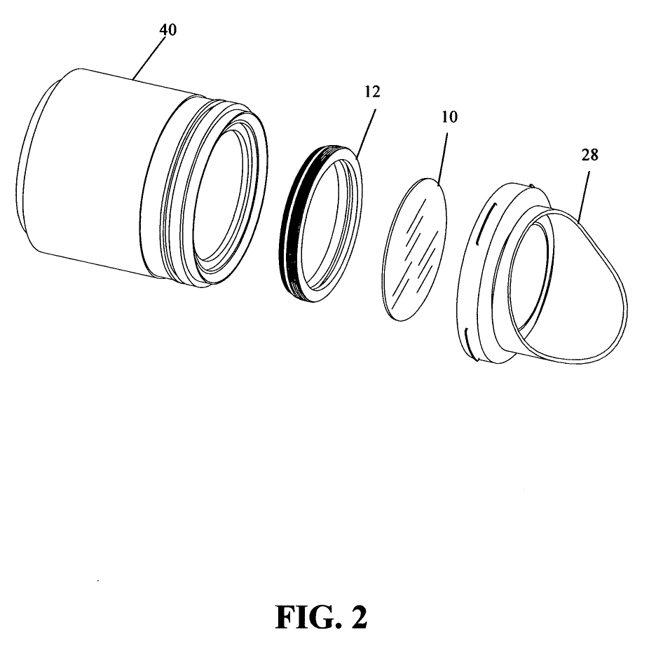

Referring to FIG. 2, the ENG viewfinder of FIG. 1 is represented in an exploded view. The ENG viewfinder consists of viewfinder body 40, cover plate carrier 12, cover plate 10 and eyecup 28.

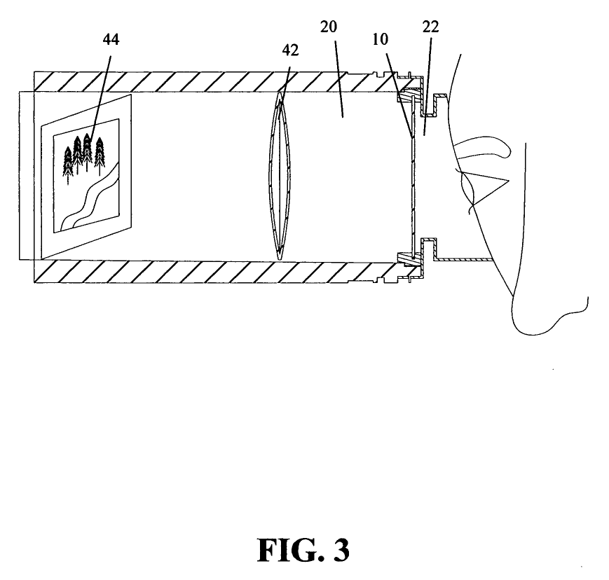

Referring now to FIG. 3, a cross sectional view of an ENG viewfinder is represented, showing monitor 44, focusing lens 42, cover plate 10, inside chamber 20 and eye chamber 22.

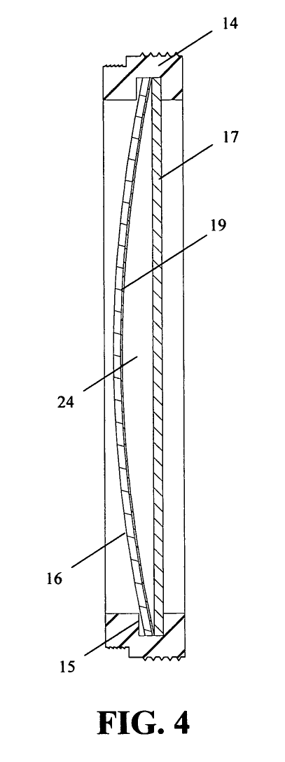

Referring now to FIG. 4, a preferred embodiment of the present invention is shown, comprising plate carrier 14 and carrier plate groove 15. Cover plate 17 and refractive plate 16 fit snugly into carrier plate groove 15 to form inter-plate space 24. Filter film 19 is disposed on the eye side of refractive plate 16 to filter harmful radiation from monitor 44 (not shown). In a preferred embodiment of the present invention the width of carrier plate groove 15 is ⅛ inch and the diameter of carrier plate groove 15 is 2 3/32 inches.

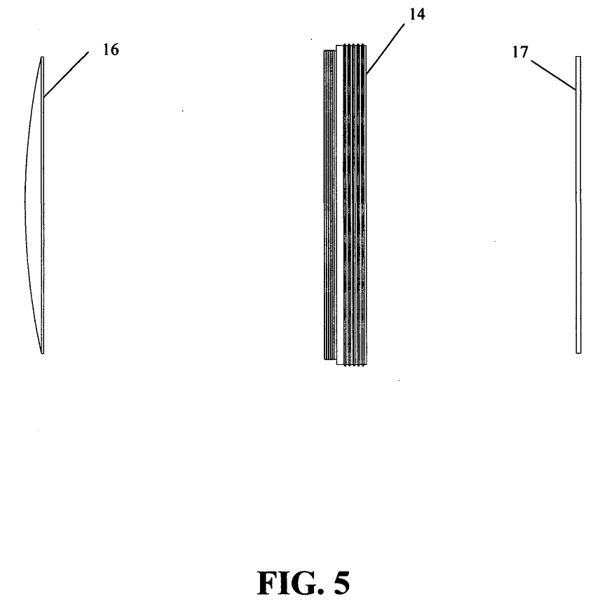

Referring now to FIG. 5, refractive plate 16, plate carrier 14 and cover plate 17 are shown in a side plan exploded view.

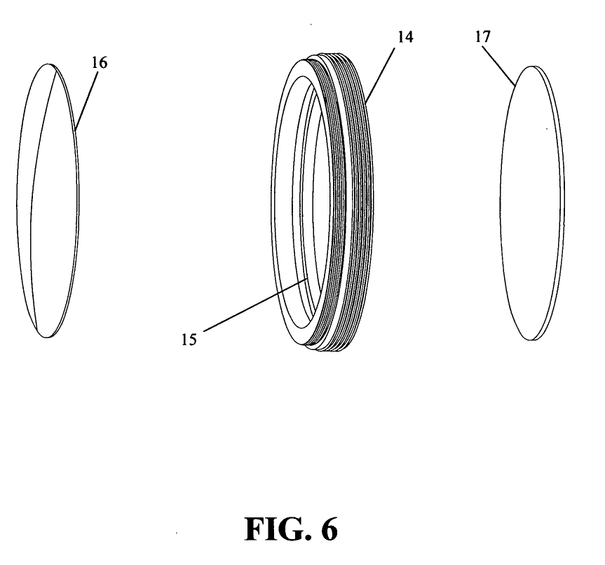

Referring now to FIG. 6, refractive plate 16, plate carrier 14 and cover plate 17 are shown in a perspective exploded view. Carrier plate groove 15 is dimensioned so that refractive plate 16 and cover plate 17 snugly fit together within carrier plate groove 15.

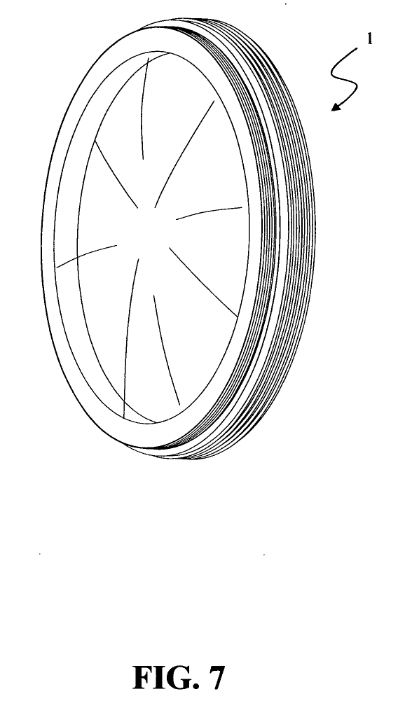

Referring now to FIG. 7, device 1 represents a perspective view of an assembled viewfinder plate assembly.

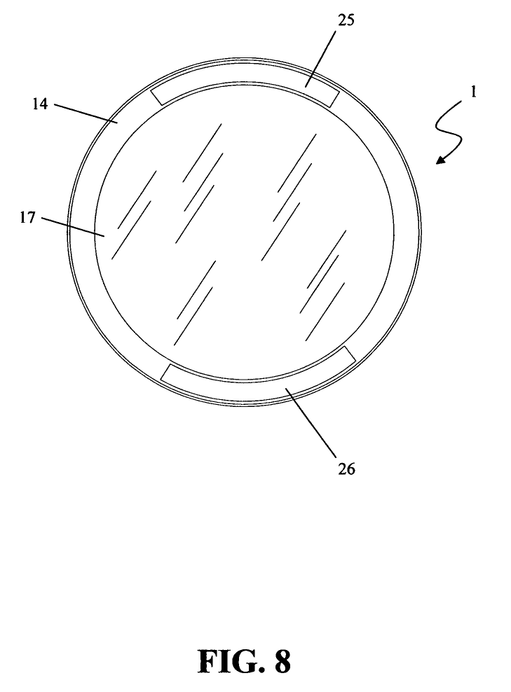

Referring now to FIG. 8, a front plan view of device 1 is shown with plate carrier 14 having refractive plate 16 (not shown) and cover plate 17 inserted. First lettering area 25 and second lettering area 26 are shown disposed on portions of the front surface of plate carrier 14. In the preferred embodiment, raised lettering is formed within first lettering area 25 giving brand information, and raised lettering is formed within second lettering area 26 giving contact information.

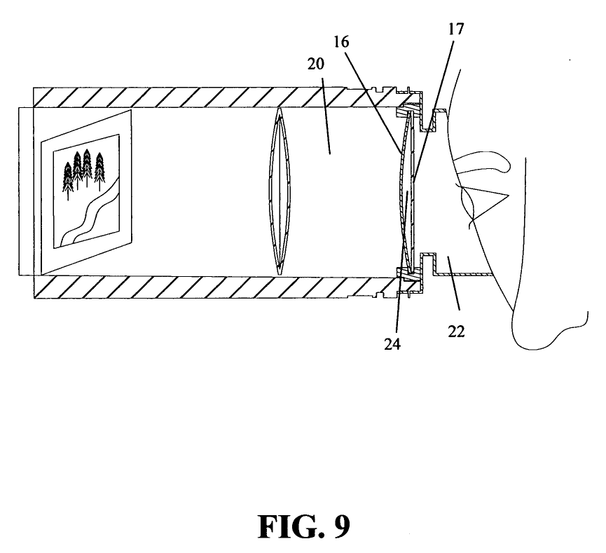

Referring now to FIG. 9, the present invention is shown installed within an ENG viewfinder. Refractive plate 16 and cover plate 17 form inter-plate space 24 as shown. This combination reduces fogging by reducing the transfer of heat from eye chamber 22 to inside chamber 20.

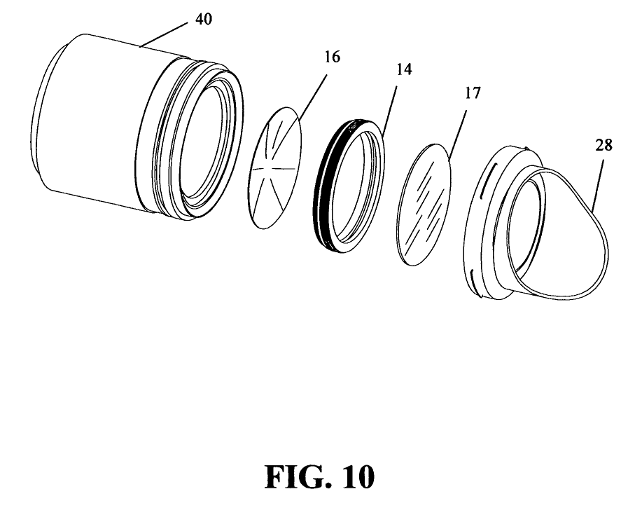

Referring now to FIG. 10, an exploded perspective view of an ENG viewfinder with a single groove embodiment of the present invention is represented. The standard cover plate carrier and cover plate have been replaced by plate carrier 14 having a single inside groove into which refractive plate 16 and cover plate 17 are inserted. Eyecup 28 is then secured to the eye-side of viewfinder body 40.

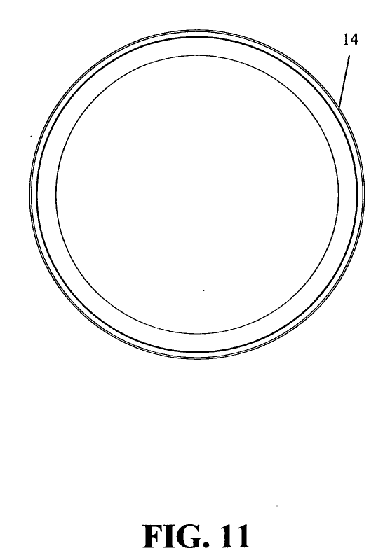

Referring now to FIG. 11, the back plan view of plate carrier 14 is shown.

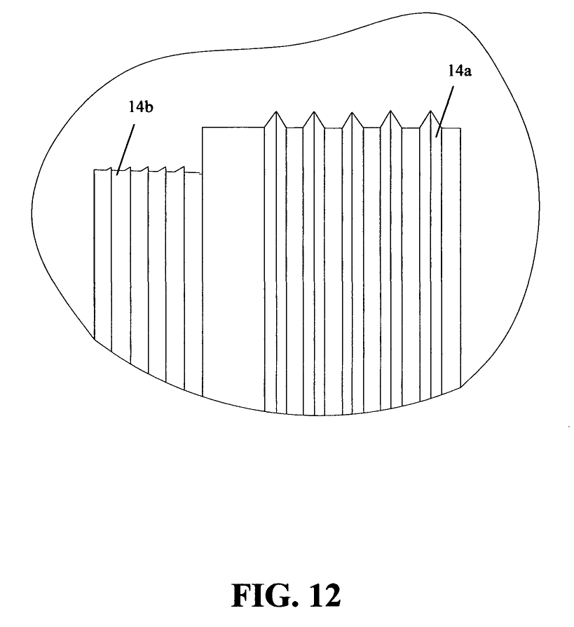

Referring now to FIG. 12, a partial side plan view of plate carrier 14 is shown to show the plurality of front ridge 14a and the plurality of back ridge 14b. In a preferred embodiment of the present invention, the diameter of front ridge 14a is 2¼ inches; the diameter of back ridge 14b is 2 5/32 inches; the width of the space between each front ridge is 1/64 inch; the width of front ridge 14a is 1/64 inch; the width of back ridge 14b is 1/64 inch; each back ridge 14b is angled at 60° as shown; each front ridge 14a is angled at 90° as shown. The design of each front ridge 14a allows the present invention to slide in easier to the viewfinder opening than to pull out of the viewfinder opening. Furthermore, as the present invention is inserted into a viewfinder opening, each back ridge 14b ratchets past the metal holding clips creating more hold.

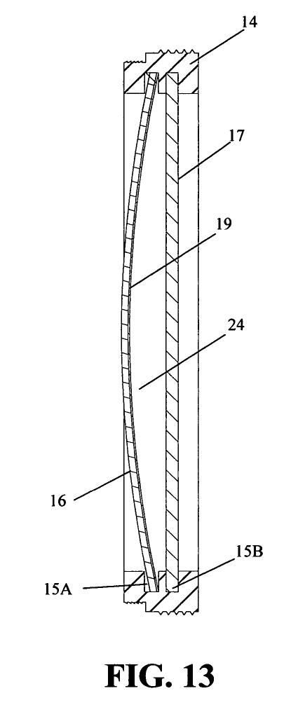

Referring now to FIG. 13, another embodiment of the present invention is represented in a side cross sectional view. This embodiment has two grooves on the inside of plate carrier 14: carrier plate groove-a 15A and carrier plate groove-b 15B. Refractive plate 16 fits snugly into carrier plate groove-a 15A and cover plate 17 fits snugly into carrier plate groove-b 15B, forming inter-plate space 24. Filter film 19 is disposed on the eye side of refractive plate 16.

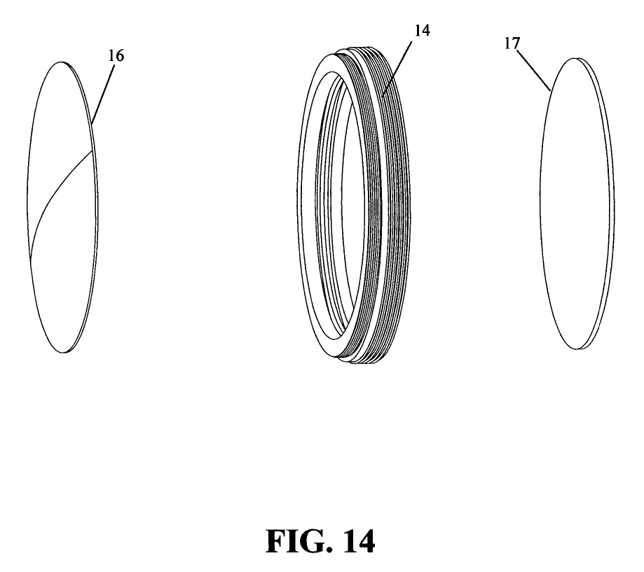

Referring now to FIG. 14, a perspective exploded view of the two groove embodiment of the present invention is represented. Refractive plate 16 and cover plate 17 are shown opposite their respective grooves within plate carrier 14.

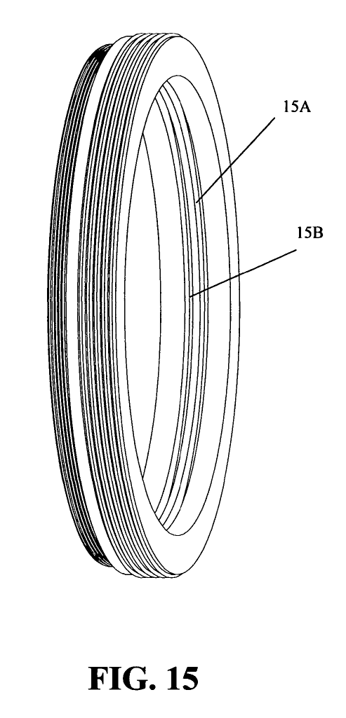

Referring now to FIG. 15, carrier plate groove-a 15A and carrier plate groove-b 15B are shown in more detail.

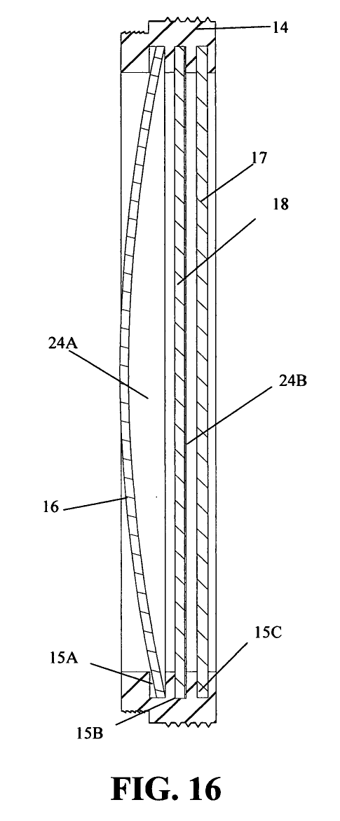

Referring now to FIG. 16, a three groove embodiment of the present invention is represented, comprising plate carrier 14 with refractive plate 16 inserted into carrier plate groove-a 15A, filter plate 18 inserted into carrier plate groove-b 15B and cover plate 17 inserted into carrier plate groove-c 15C. Inter-plate space-a 24A is formed between refractive plate 16 and filter plate 18. Inter-plate space-b 24B is formed between filter plate 18 and cover plate 17. The combination of inter-plate space-a 24A and inter-plate space-b 24B gives additional anti-fogging qualities to this embodiment of the present invention.

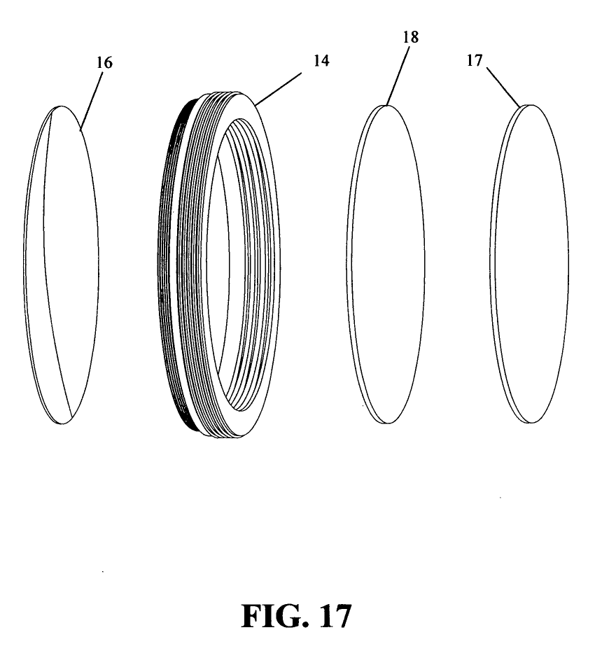

Referring now to FIG. 17, a perspective exploded view of the three groove embodiment of the present invention is represented, showing refractive plate 16, plate carrier 14, filter plate 18 and cover plate 17.

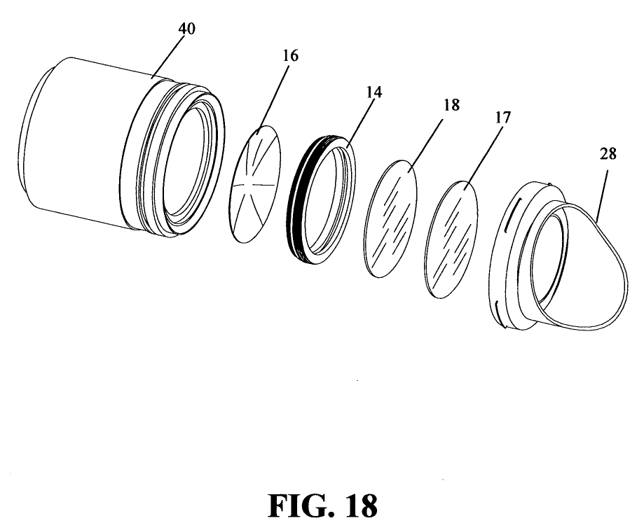

Referring now to FIG. 18, an exploded perspective view of an ENG viewfinder with a three groove embodiment of the present invention is represented. The standard cover plate carrier and cover plate have been replaced by plate carrier 14 having three inside grooves into which refractive plate 16, filter plate 18 and cover plate 17 are inserted. Eyecup 28 is then secured to viewfinder body 40.

The EMF radiation blocking and antifogging qualities exist regardless of whether the plate surfaces are flat or curved or a combination of flat and curved surfaces. Additionally while the inter-plate space of the preferred embodiment has been described as filled with air, if the R-value of the eyepiece assembly needs to be higher, another gas, e.g. argon, could be used to fill the inter-plate space in order to raise the R-value. One method of having another gas in the inter-plate space is to assemble the present invention within a closed containment space that contains that selected gas.

The fogging problem of a current ENG video camera viewfinder is due to the cooling of the outermost, eye-side eyepiece plate. Once its temperature falls to the dew point for eye chamber conditions, eyepiece plate fogging occurs. In the preferred embodiment of the present invention, the inter-plate space passively impedes the movement of heat away from the eye chamber and therefore delays the cooling of the eye-side eyepiece plate. An alternative embodiment of the eyepiece assembly may involve some active means of delaying the loss of heat through the eyepiece assembly, thus delaying the onset of condensation conditions on the eye-side eyepiece plate. For example, the cameraman could preheat the eyepiece assembly and install it immediately before videotaping. Thus, the cooling down of the eyepiece plates and inter-plate space is further delayed, and the anti-fog properties of this embodiment are further enhanced.

The manner of using the viewfinder eyepiece assembly shown in FIG. 7 to enhance views of video monitors is identical to that for a dust cover plate assembly shown in FIG. 2 that currently comes with the stock viewfinders. The ENG cameraman simply removes the manufacturer's viewfinder dust cover plate assembly and replaces it with the present invention. The securing means of the preferred embodiment is elastomer deformation return expansion pressure. In this embodiment plate carrier 14 is flexible and is firmly pushed, by hand force, into the tube opening until it seats snuggly and securely. Another securing means could be by screw-thread attachment. In that instance, plate carrier 14 may be made of rigid plastic or metal with a screw-threaded outer edge. Plate carrier 14 is then screwed into a complementarily screw-threaded viewfinder opening. The viewfinder assembly is fully functional in this position. There are no moving parts. No other action needs to be applied, other than occasionally cleaning the external eye-side surface. The assembly can remain in this position or be moved to another viewfinder.

The effectiveness of the eyepiece assembly to prevent fogging is due to the inhibition of the movement of heat from eye chamber 22 to the colder inside chamber 20. The present invention shown in FIG. 10 has a higher R-value than the current original equipment cover plate assembly shown in FIG. 2. The higher R-value is mainly due to the dead-air in inter-plate space 24 between the refractive plate 16 and cover plate 17 within the viewfinder eyepiece assembly. Inter-plate space 24 impedes the heat flow between eye chamber 22 and inside chamber 20. In the preferred embodiment, the plates' circumferences are made slightly larger than the elastomer carrier's inner groove circumferences. Elastomer deformation return pressure on the plates' edges creates a substantially airtight space between the plates.

Filter plate 18 possesses means for selectively blocking or reducing the transmittance of certain potentially unhealthy EMF radiations emitted from the video display or monitor 44. One method of blocking certain radiations is to manufacture at least one of refractive plate 16, filter plate 18 or cover plate 17 using a material that possesses inherent EMF blocking properties. For example, ultraviolet light frequencies are almost totally blocked by polycarbonate plastic or Optivex™ glass. These plate or lens materials are substantially transparent in the safe visible light range. Application of a coating onto the surface of refractive plate 16, filter plate 18 or cover plate 17 is another means of blocking predetermined wavelengths. Epolight™ is an example of a transparent, infrared-blocking plate or lens coating.

Still another embodiment of the present invention may be described as an eyepiece assembly for an ENG video camera monitor viewing tube comprising a plurality of thin, substantially transparent plates, each plate possessing a continuous edge and two surfaces, a carrier which surrounds the edges of the plates providing holding means for the plates into the viewing tube where the plates are positioned between the monitor and a viewer's eye, holding the plate surfaces in a substantially perpendicular relationship to the viewer's visual axis, holding the plate surfaces either in a non-contacting relationship with each other or in a peripheral contacting relationship with each other, and an inter-plate space, between the plates, surrounded by the plates and the carrier, filled with a substantially transparent, non-solid substance whereby the transfer of heat from the viewer's side of the plates to the monitor side of the plates is inhibited, thus delaying the formation of condensation on the eye side plate. The non-solid substance filling the inter-plate space may be a gas or a liquid. The embodiment may contain a plurality of inter-plate spaces formed by multiple plates inserted into multiple grooves within the carrier.

Furthermore, another embodiment of the present invention may be described as an ENG video camera monitor viewing assembly comprising a viewing tube having a monitor end and a viewing end, an eyecup operably engaging the viewing end of the viewing tube and a viewfinder eyepiece assembly for the ENG video camera monitor viewing assembly comprising a removable plate carrier with a first carrier plate groove and a second carrier plate groove, a refractive plate operably disposed within the first carrier plate groove, a filter plate operably disposed within the second plate groove, and an inter-plate space formed between the refractive plate and the filter plate.

The preferred method of making the present invention is as follows:
Mold a plate carrier out of nitrile elastomer
   with a durometer rating of 40 Shore A for appropriate compression and elasticity qualities
   a ring shape with a diameter and profile matching that of the existing cover plate carrier that it replaces
   with the outer edges of the carrier having circumferentially oriented, friction-increasing ridges to give it greater securing hold after the carrier is positioned into the viewfinder
   one or more plate-holding channels, or grooves, located circumferentially within the interior edge of the carrier, into which the plates are inserted, providing the holding means for the plates.
Cut each eyepiece assembly plate to a diameter slightly larger than that of the plate-holding channel's outer edge so that the elasticity of the ring will provide an inward force such that the carrier snuggly surrounds the plate's edge.
   If two or more carrier plate channels are formed, the carrier is stretched over and completely around each of the two or more plates such that each plate's edge fits securely into one of the channels.
   Orient each plate with its most concave surface facing the inter-plate space formed by the minimum two plates, thus maximizing the inter-plate volume thereby maximizing the anti-fogging benefits described herein.
   If only one carrier plate channel is formed, the minimum two plates are inserted together into the same channel.
   Ensure that at least one concavely-curved plate surface is inserted into the single channel facing the other plate's flat or concavely-curved surface such that the two plates are in peripheral contact with each other while centrally forming the inter-plate space required to decrease fogging tendencies, herein described.
   If a gas-tight, gas filled inter-plate space eyepiece assembly is desired, the two plates are positioned as in the one channel carrier case, i.e. at least one concavely-curved plate surface is facing the other plate's flat or concavely-curved surface such that the two plates are in peripheral contact with each other while forming the inter-plate space centrally.
   To fill the inter-plate space with a gas, the two plates are peripherally glued together within a sealed laboratory-type glove-box apparatus filled with the desired gas. The two-plate unit is then inserted into the elastomer carrier plate channel.
   To fill the inter-plate space with a liquid, the two plates are positioned as in the one channel carrier case, i.e. at least one concavely-curved plate surface is facing the other plate's flat or concavely-curved surface such that the two plates are in peripheral contact with each other while forming the inter-plate space centrally.
   To create the liquid filled inter-plate space, the two plates are submerged in a container filled with the desired liquid and peripherally glued together with an adhesive that binds in the presence of that liquid. The two-plate unit is then inserted into the elastomer carrier plate channel.

Other embodiments, uses and advantages of the present invention will be apparent to those skilled in the art from consideration of the specification and practice of the invention disclosed herein. The specification and examples should be considered exemplary only.

What is claimed is:

1) An eyepiece assembly for an ENG video camera monitor viewing tube comprising:
a plurality of thin, substantially transparent plates, wherein each plate possessing a continuous edge and two surfaces;
a carrier;
means for holding said plates; and
means for securing said carrier within said viewing tube;
wherein said transparent plates are in a substantially perpendicular relationship to a viewer's visual axis, wherein said plate surfaces are in a substantially non-contacting relationship with each other, wherein at least one space is formed between said plates, wherein said at least one space is filled with a substantially transparent, non-solid substance.

2) The eyepiece assembly of claim 1, wherein at least one of said thin, substantially transparent plates is selected from the group of plates consisting of biconvex, plano-convex, convex-concave, meniscus, plano-concave, and biconcave.

3) The eyepiece assembly of claim 2, further comprising means for filtering electromagnetic radiation.

4) The eyepiece assembly of claim 3 wherein said substantially transparent, non-solid substance is air.

5) The eyepiece assembly of claim 3 wherein said substantially transparent, non-solid substance is a gas.

6) The eyepiece assembly of claim 3 wherein said substantially transparent, non-solid substance is a liquid.

7) A method of making an eyepiece assembly for an ENG video camera monitor viewing tube, comprising:
molding a plate carrier out of nitrile elastomer, wherein said plate carrier is characterized by a durometer rating of 40 Shore A, dimensioned to fit said monitor viewing tube, an outer edge having circumferentially oriented, friction-increasing ridges, at least one plate-holding channel located circumferentially within the interior edge of the carrier and dimensioned for insertion of at least one plate;
cutting at least two plates to a diameter slightly larger than that of said outer edge of said plate-holding channel; and
inserting said two plates into said at least one plate-holding channel such that an inter-plate space is formed.

8) A viewfinder eyepiece assembly for an ENG video camera monitor viewing tube comprising:
a removable plate carrier having an outside diameter and an inside diameter, operable for releasable insertion into said viewing tube, with a single channel disposed in said inside diameter operable for releasable insertion of plates;
a refractive plate operably disposed within said single channel;
a non-refractive plate operably disposed within said single channel; and
an inter-plate space formed between said refractive plate and said non-refractive plate.

9) The viewfinder eyepiece assembly for an ENG video camera monitor viewing tube of claim 8, further comprising means for filtering EMF radiation.

10) The viewfinder eyepiece assembly for an ENG video camera monitor viewing tube of claim 9, wherein said means for filtering EMF radiation is said refractive plate made of polycarbonate material.

11) The viewfinder eyepiece assembly for an ENG video camera monitor viewing tube of claim 9, wherein said means for filtering EMF radiation is said non-refractive plate made of polycarbonate material.

12) The view finder eyepiece assembly for an ENG video camera monitor viewing tube of claim 9, wherein said means for filtering EMF radiation is a coating on at least one side of said refractive plate.

13) The viewfinder eyepiece assembly for an ENG video camera monitor viewing tube of claim 9, wherein said means for filtering EMF radiation is a coating on at least one side of said non-refractive plate.
